(19) United States
(12) Patent Application Publication
(10) Pub. No.: US 2014/0164989 A1
(43) Pub. Date: Jun. 12, 2014

(54) DISPLAYING WINDOWS ON A TOUCHSCREEN DEVICE

(71) Applicant: Stefan KUHNE, San Jose, CA (US)

(72) Inventor: Stefan KUHNE, San Jose, CA (US)

(21) Appl. No.: 13/710,397

(22) Filed: Dec. 10, 2012

(51) Int. Cl. G06F 3/0484

(52) U.S. Cl. CPC G06F 3/04847
USPC 715/790

(57) ABSTRACT

A system and machine-implemented method for displaying windows on a touchscreen device. Plural graphical objects are displayed on a touchscreen of the touchscreen device, each graphical object being associated with an application. Multiple touch presses that are at least partially overlapping in time are detected on the touchscreen, each touch press corresponding to a respective one of the plural graphical objects. The applications associated with the graphical objects corresponding to the multiple touch presses are identified. A release of the multiple touch presses is detected. In response to detecting the release, a display arrangement to reduce overlapping of windows for the identified applications is determined. The windows for the identified applications are displayed on the touchscreen based on the determined display arrangement.

### BACKGROUND

The present disclosure generally relates to touchscreen devices and, in particular, to displaying windows on a touchscreen device.

Desktop user interfaces can run multiple windows/applications at the same time. To view multiple windows together on a screen, a user may open the windows individually, hide existing windows, and position the opened windows side-by-side so as not to overlap.

### SUMMARY

The disclosed subject matter relates to a method displaying windows on a touchscreen device. The method comprises displaying plural graphical objects on a touchscreen of the touchscreen device, each graphical object being associated with an application, and detecting, on the touchscreen, multiple touch presses that are at least partially overlapping in time, each touch press corresponding to a respective one of the plural graphical objects. The method further comprises identifying the applications associated with the graphical objects corresponding to the multiple touch presses, and detecting a release of the multiple touch presses. In addition, the method comprises determining, in response to detecting the release, a display arrangement to reduce overlapping of windows for the identified applications, and displaying, based on the determined display arrangement, the windows for the identified applications on the touchscreen.

The disclosed subject matter further relates to a system for displaying windows. The system comprises a touchscreen, one or more processors, and a machine-readable medium comprising instructions stored therein, which when executed by the processors, cause the processors to perform operations comprising displaying plural graphical objects on the touchscreen, each graphical object being associated with an application already running or to be invoked. The operations further comprise detecting, on the touchscreen, multiple touch presses that are at least partially overlapping in time, each touch press corresponding to a respective one of the plural graphical objects, and identifying the applications associated with the graphical objects corresponding to the multiple touch presses. In addition, the operations comprise detecting a release of the multiple touch presses, determining, in response to detecting the release, a display arrangement to reduce overlapping of windows for the identified applications, and displaying, based on the determined display arrangement, the windows for the identified applications on the touchscreen.

The disclosed subject matter also relates to a machine-readable medium comprising instructions stored therein, which when executed by a system, cause the system to perform operations comprising displaying plural graphical objects on a touchscreen of a touchscreen device, each graphical object being associated with an application, detecting, on the touchscreen, multiple touch presses that are at least partially overlapping in time, each touch press corresponding to a respective one of the plural graphical objects, and identifying the applications associated with the graphical objects corresponding to the multiple touch presses. The operations further comprise detecting a release of the multiple touch presses, determining, in response to detecting the release, a display arrangement of windows for the identified applications, and displaying, based on the determined display arrangement, the windows for the identified applications on the touchscreen.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several embodiments of the subject technology are set forth in the following figures.

FIG. 1 illustrates an example network environment which can provide for displaying windows on a touchscreen device.

FIGS. 2A-2B illustrate an example of a user interface for arranging windows on a touchscreen device.

FIGS. 3A-3B illustrate another example of a user interface for arranging windows on a touchscreen device.

FIGS. 4A-4C illustrate another example of a user interface for arranging windows on a touchscreen device.

FIG. 5 illustrates an example process by which windows on a touchscreen device are displayed.

FIG. 6 conceptually illustrates an example electronic system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As noted above, desktop user interfaces can run multiple windows/applications at the same time. To view multiple windows together on a screen, a user may open the windows individually, hide existing windows, and position the opened windows side-by-side so as not to overlap.

The subject disclosure provides for displaying windows on a touchscreen device, which includes a touchscreen. As used herein, “touchscreen” encompasses its plain and ordinary meaning, including but not limited to, an electronic visual display that can detect the presence and location of a touch within the display area. Plural graphical objects (e.g., icons, windows) are displayed on the touchscreen of the touchscreen device, each graphical object being associated with an application. Multiple touch presses (e.g., by multiple fingers) that are at least partially overlapping in time are detected on the touchscreen, each touch press corresponding to a respective one of the plural graphical objects. The applications associated with the graphical objects corresponding to the multiple touch presses are identified. A release of the multiple touch presses is detected. In response to detecting the release, a display arrangement of windows for the identified applications is determined (e.g., to reduce overlapping of the windows). The windows for the identified applications are displayed on the touchscreen based on the determined display arrangement.

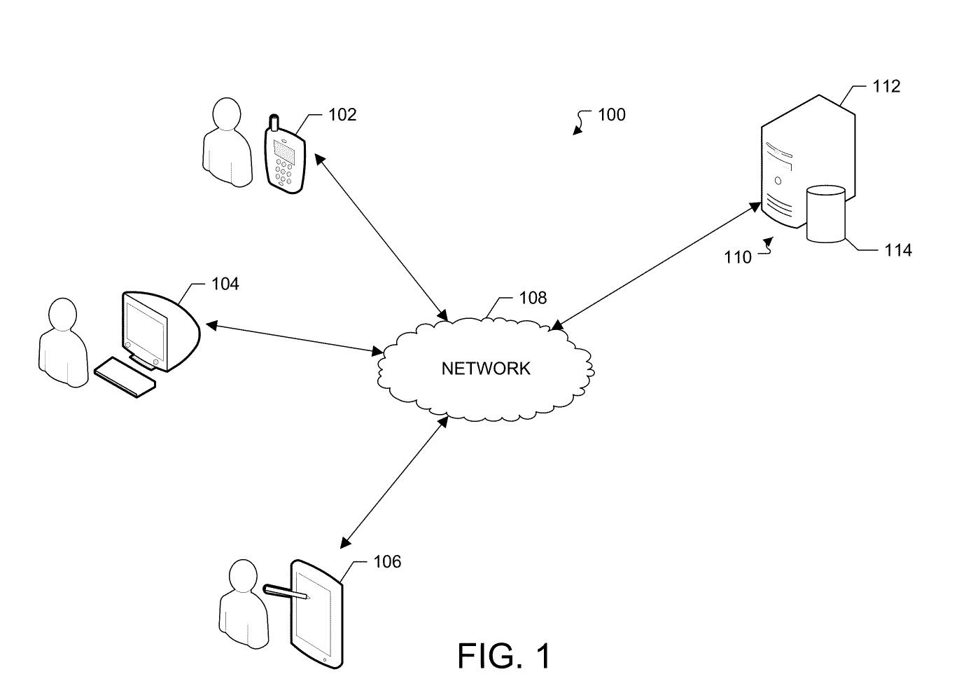

FIG. 1 illustrates an example network environment which can provide for displaying windows on a touchscreen device. A network environment 100 includes computing devices 102, 104 and 106 and computing system 110. Computing devices 102-106 and computing system 110 can communicate with each other through a network 108. Each of electronic devices 102-106 can include a touchscreen, which can be built into the device itself or can be electronically connected to the device (e.g., as a peripheral device). Computing system 110 can include one or more computing devices 112 (e.g., one or more servers), respectively, and one or more computer-readable storage devices 114 (e.g., one or more databases), respectively.

Each of computing devices 102-106 can represent various forms of processing devices. Example processing devices include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, a television, or a combination of any these data processing devices or other data processing devices. Computing devices 102-106 and 112 may be provided access to or receive application software executed or stored on any of the other computing systems 102-106 and 112.

Computing device 112 may be any system or device having a processor, a memory, and communications capability for providing content to the electronic devices. In some example aspects, server 110 can be a single computing device, for example, a computer server. In other embodiments, server 110 can represent more than one computing device working together to perform the actions of a server computer (e.g., cloud computing). Further, computing device 112 can represent various forms of servers including, but not limited to a web server, an application server, a proxy server, a network server, or a server farm.

In some aspects, the computing devices may communicate wirelessly through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, WiFi, or other such transceiver.

In some aspects, network environment 100 can be a distributed client/server system that spans one or more networks, for example, network 108. Network 108 can be a large computer network, for example, a local area network (LAN), wide area network (WAN), the Internet, a cellular network, or a combination thereof connecting any number of mobile clients, fixed clients, and servers. Further, the network 108 can include, but is not limited to, any one or more of the following network topologies, including a bus network, a star network, a ring network, a mesh network, a star-bus network, tree or hierarchical network, and the like. In some aspects, communication between each client (e.g., computing devices 102-106) and server (e.g., server 110) can occur via a virtual private network (VPN), Secure Shell (SSH) tunnel, or other secure network connection. In some aspects, network 108 may further include a corporate network (e.g., intranet) and one or more wireless access points.

In example aspects, any of computing devices 102-106 can include a touchscreen, and can provide for displaying windows on the touchscreen. The computing device displays plural graphical objects (e.g., icons, windows) on the touchscreen, each graphical object being associated with an application. For example, one or more of the applications can be locally-stored applications running on the computing device. Alternatively, or in addition, one or more of the applications can be remote applications (e.g., hosted by server 110) and accessible by the computing device. The computing device detects, on the touchscreen, multiple touch presses (e.g., by multiple fingers) that are at least partially overlapping in time, each touch press corresponding to a respective one of the plural graphical objects. The computing device identifies the applications associated with the graphical objects corresponding to the multiple touch presses, and detects a release of the multiple touch presses. The computing device determines, in response to detecting the release, a display arrangement of windows for the identified applications (e.g., to reduce overlapping of the windows). The computing device displays, based on the determined display arrangement, the windows for the identified applications on the touchscreen.

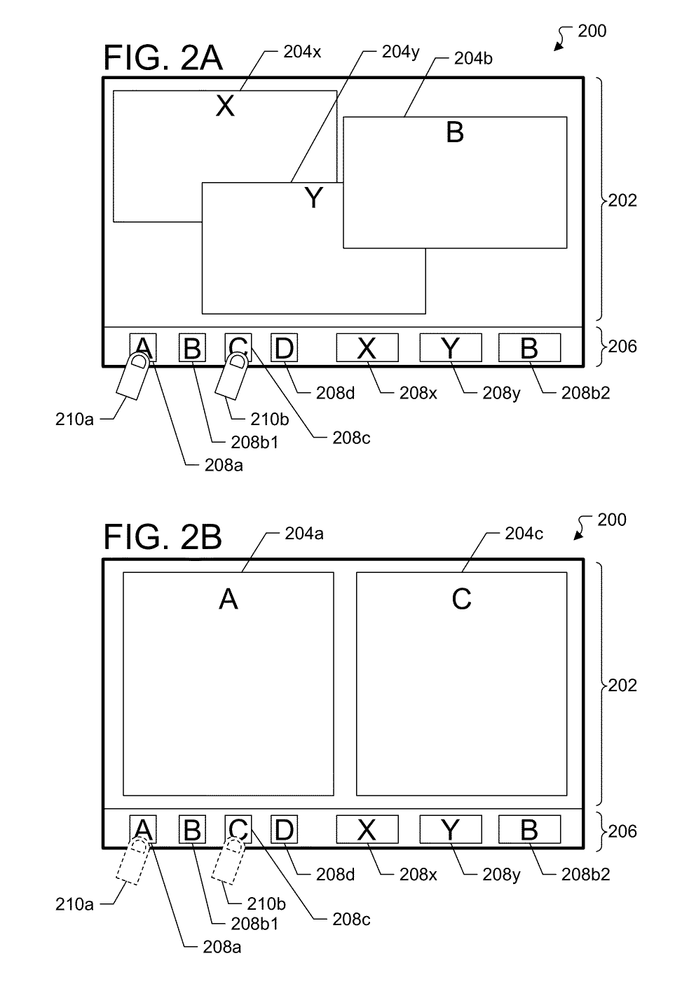

FIGS. 2A-2B illustrate an example of a user interface for arranging windows on a touchscreen device. In example aspects, touchscreen 200 is included as part of a touchscreen device (e.g., any of computing devices 102-106). Touchscreen 200 is an electronic visual display that can detect the presence and location of a touch (e.g., via a finger, stylus, etc.) within the display area. The display area of touchscreen 200 includes a window region 202 and a taskbar 206. Window region 202 displays applications which are currently running on the touchscreen device (e.g., any of computing devices 102-106). Taskbar 206, on the other hand, is used to launch and monitor running applications.

Although window region 202 is displayed above taskbar 206, it should be noted that different arrangements (e.g., side-by-side, taskbar 206 on top) can be used. In addition, taskbar 206 can be replaced by or supplemental to an interface which is hidden until a user specifies to see available applications (e.g., a “start” button which displays available applications upon user selection).

In the example of FIG. 2A, window region 202 displays three windows, namely 204x, 204y and 204b. Displayed windows respectively correspond to instances of applications X, Y and B, all of which are currently running Applications X, Y and B correspond to any application which can run on the touchscreen device. Examples of such applications include, but are not limited to word processors, spreadsheets, messaging applications, web browsers, graphics applications, email applications, calendar applications and programming applications.

Taskbar 206 displays applications which can be invoked, and applications which are already running For example, icons 208a, 208b1, 208c and 208d correspond to applications which can be invoked. Such applications can include, but are not limited to word processors, spreadsheets, messaging applications, web browsers, graphics applications, email applications, calendar applications and programming applications. Taskbar 206 also displays icons 208x, 208y and 208b2, corresponding to applications which are running More particularly, icons 208x, 208y and 208b2 respectively correspond to windows 204x, 204y and 204b, which correspond to running instances of applications X, Y and B.

Although not shown in FIG. 2A, taskbar 206 can also display icons for other applications which are running but hidden from view. One example of an application hidden from view is a minimized application. Icons corresponding to minimized applications can be displayed within taskbar 206 (not shown in FIG. 2A). Another example of an application hidden from view is an application included within a virtual workspace which is currently not visible. For example, the touchscreen device can include functionality to switch between multiple virtual workspaces, with window region 202 corresponding to a virtual workspace which is currently visible and the remaining virtual workspaces being out of view.

As seen in FIG. 2A, windows 204x, 204y and 204b overlap each other. A user of the touchscreen device may wish to close all existing windows (e.g., windows 204x, 204y and 204b) and invoke other applications. In example aspects, using a single gesture, the user can simultaneously touch the respective icons in the taskbar to invoke the applications, or to make the applications visible (e.g., if the applications are already running) It should be noted that “simultaneous” touching of the respective icons does not necessarily correspond to the touches being initiated at the same time. In example aspects, the simultaneous touching can simply require that both icons be depressed during a shared time period such that the presses are at least partially overlapping in time, regardless of which icon was pressed first.

In FIG. 2A, user presses icons 208a and 208c using fingers 210a and 210b. Of course, other forms of touch input can be used instead of finger input (e.g., a stylus, or a combination of finger and stylus input). The touchscreen device can detect the multiple touch presses on touchscreen 200. The touchscreen device can also identify the applications (e.g., applications A and C) associated with the touched icons 208a and 208c. In example aspects, these identified applications can be saved in local memory (e.g., memory of computing device 102-106) within a list of identified applications.

The touchscreen device can also detect a release of the multiple touch presses. It should be noted that the release of the multiple touch presses can correspond to a release of the multiple touch presses at the same time, or can correspond to a release of the multiple touch presses within a predetermined threshold of time.

With reference to FIG. 2B, the dotted lines for fingers 210a and 210b represent that the touch press for fingers 210a and 210b is released. Upon detecting the release of fingers 210a and 210b from icons 208a and 208c, the touchscreen device can invoke applications A and C, and determine a display arrangement of windows for applications A and C (e.g., to reduce overlapping of windows). More particularly, the touchscreen device can hide the display of windows 204x, 204y and 204b within window region 202, and invoke applications A and C for display within windows 204a and 204c.

Hiding the display of windows 204x, 204y and 204b can occur in various manners. In a first example, windows 204x, 204y and 204b can be minimized. In another example, windows 204x, 204y and 204b can be pushed into a virtual workspace which is not currently visible. In yet another example, the instances of applications X, Y and B can be closed, thereby removing windows 204x, 204y and 204b from display. In example aspects, the different manners for hiding windows can be specified by the user.

Furthermore, the invoking and display of windows 204a and 204c can occur in various manners. For example, the touchscreen device can traverse through the list of identified applications stored in local memory. The touchscreen device can display windows 204a and 204c in a non-overlapping manner. In another example, windows 204a and 204c can be displayed so reduce (but not eliminate) overlapping. In this example, a majority portion of each of windows 204a and 204c can be non-overlapping with respect to each other.

In example aspects, displaying the windows in a non-overlapping manner or with reduced overlapping is optional, and the display of windows can be varied in other manners in response to detecting the release of multiple touch presses. In this regard, a user may specify the manner in which the windows are displayed, and the touchscreen device can display the windows based on user-specified settings.

The ordering of windows 204a and 204c within window region 202 can be based on the order in which touch presses were received. For example, if the initial pressing of icon 208a was detected by the touchscreen device before the pressing of icon 208c, window 204a may be displayed on the left of window region 202, while remaining window 204c is displayed on the right of window region 202. In example aspects, the order in which windows 204a and 204c were initially touched can be stored locally in memory (e.g., in association with the stored list of identified applications).

Although not shown in the example of FIGS. 2A-2B, it is possible for the touch press to be made in association with an already running program. For example, the touchscreen device can detect a finger press to icon 208a and 208x and detect a release of these finger presses. In response, the touchscreen device can close existing windows 204y and 204b (e.g., corresponding to applications Y and B), can invoke application A, and can arrange for the display of windows 204a and 204x with reduced overlapping (e.g., non-overlapping).

In addition, it should be noted that touch input is not limited to two touch presses, and that a larger number of touch presses (e.g., 3, 4 or 5) can be used. For example, in addition to pressing icons 208a and 208c, a user may also press icon 208d (e.g., with a third finger). The user may release the multiple touch presses for icons 208a, 208c and 208d. In response to detecting the multiple touch presses and their subsequent release, the touchscreen device can display windows for applications A, C and D in a non-overlapping manner within window region 202.

It should also be noted that multiple simultaneous touch presses followed by a release of the touch presses can invoked in different manners. In one example sequence, the user can press, hold and release the press of icons. In another example sequence, the user can quickly press icons and release the press, without holding the press (e.g., a tap gesture). In example aspects, the touchscreen device can detect each of these sequences of touch input gestures, and determine that each sequence corresponds to multiple touch presses of icons followed by a release of the touch presses for the icons.

It should be noted that in addition detecting simultaneous touch presses for icons, the touchscreen device can also detect simultaneous touch presses made in association with windows. For example, if a user presses an icon (e.g., any of icons 208a-208y) and a window (e.g., any of windows 204x, 204y or 204b) simultaneously, the touchscreen device can detect this input. Upon detecting release of these two touch presses, the touchscreen device can display a window for the application corresponding to the icon, and the touched window in a manner with reduced overlapping (e.g., as non-overlapping windows).

Moreover, the user may be provided with a gesture for cancelling the display of windows in a non-overlapping manner. For example, with reference to FIGS. 2A-2B, the user can perform a slide gesture (e.g., in a downward direction) to indicate cancellation. The touchscreen device can detect the slide gesture made in association with the touch presses of icons (e.g., icons 208a and 208b1), and can terminate the process for displaying windows to reduce overlapping. For example, if a list of identified applications is stored locally, the touchscreen device can clear the list. Of course, other gestures besides a downward slide gesture can be used to indicate cancellation (e.g., a swipe gesture in another direction, or another type of touch input).

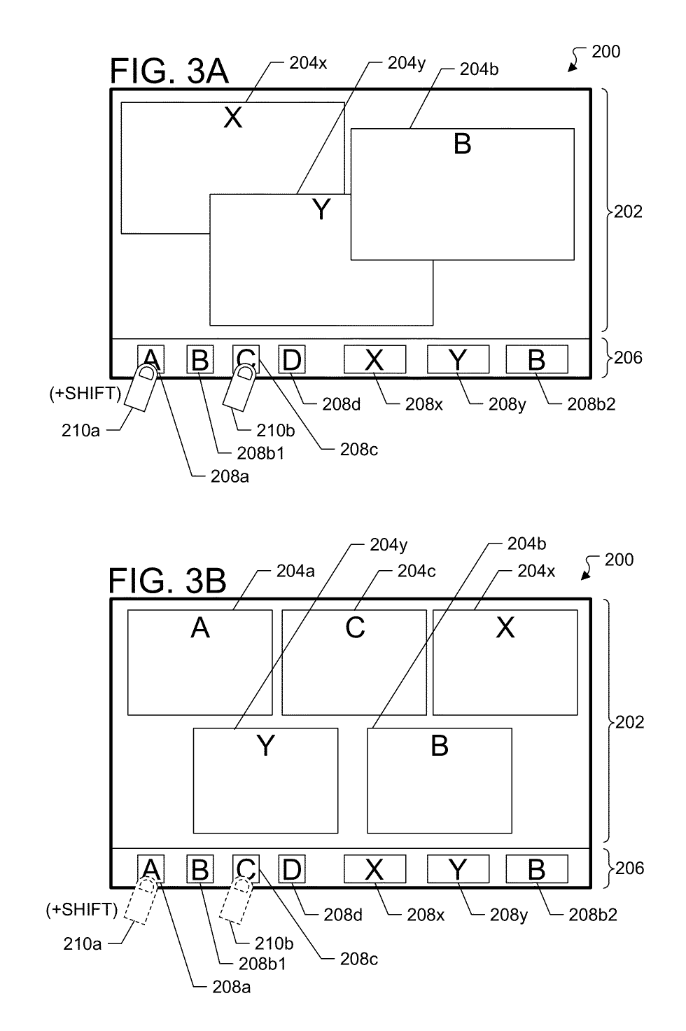

FIGS. 3A-3B illustrate another example of a user interface for arranging windows on a touchscreen device. As noted above with reference to FIGS. 2A-2B, existing windows 204x, 204y and 204b are hidden from view and substituted with windows 204a and 204c, upon detection by the touchscreen device that fingers 210a and 210b are released. However, in example aspects, the user may indicate that the existing windows should be maintained and not hidden from view.

As seen in FIG. 3A, the touchscreen device detects that icons 208a and 208c are simultaneously pressed (e.g., pressed during a shared time period such that the presses are at least partially overlapping in time, regardless of which icon is pressed first) while the user presses the SHIFT key. The SHIFT key can be pressed from a keyboard of the touchscreen device (e.g., an integrated keyboard or an external peripheral) or from another part of the touchsreen (not shown). In FIG. 3B, the pressing of icons 208a and 208c by fingers 210a and 210b are released while the SHIFT key is depressed. The pressing of the SHIFT key in conjunction with the simultaneous pressing of fingers 210a and 210b and subsequent release of fingers 210a and 210b, can signal the touchscreen device to maintain existing windows 204x, 204y and 204b.

It should be noted that the SHIFT key is one example of user input indicating to maintain existing windows, and that other user inputs can be used instead. For example, other keys or touch input gestures can be used as an alternative to, or in addition to, the SHIFT key.

With reference to FIG. 3B, all of windows 204x, 204y and 204b are displayed within window region 202, together with windows 204a and 204c, corresponding to invoked instances of applications A and C. Windows 204x, 204y, 204b, 204a and 204c can be displayed in a non-overlapping manner, or in a manner with reduced overlapping. The ordering of windows 204x, 204y, 204b, 204a and 204c within window region 202 can be based on the order in which touch presses were received. For example, if the pressing of icon 208a was detected before the pressing of icon 208c, window 204a may be displayed in the top-left area of window region 202, while remaining windows 204c, 204x, 204y, 204b are displayed in order after window 204a, within window region 202.

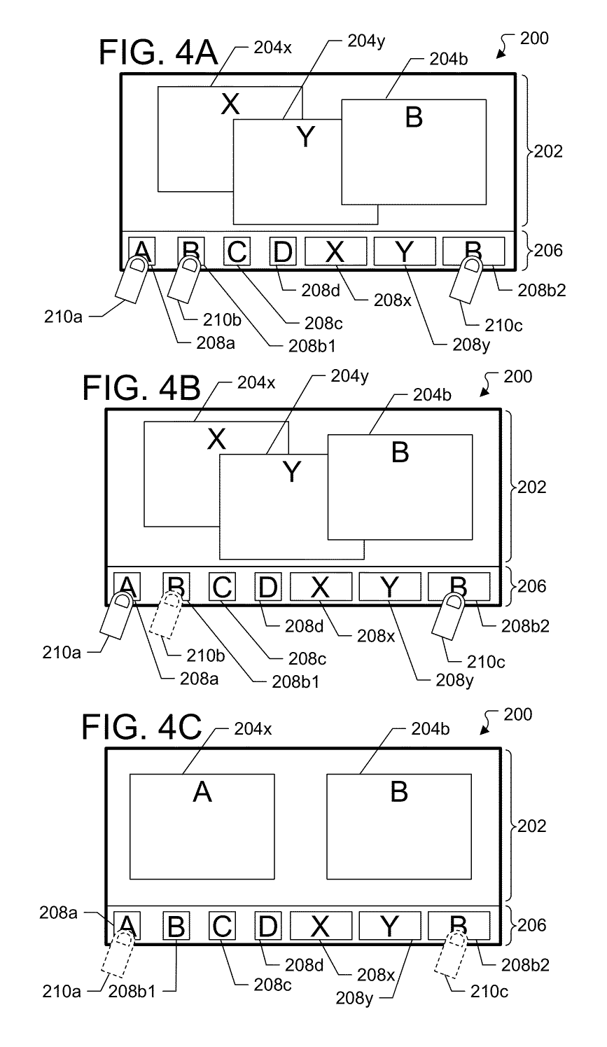

FIGS. 4A-4C illustrate another example of a user interface for arranging windows on a touchscreen device. As noted above, the touchscreen device (e.g., any of computing devices 102-106) can detect that more than two touch presses are received for icons within taskbar 206. In the example of FIG. 4A, a user may simultaneously press icons 208a, 208b1, and 208b2 (e.g., during a shared time period such that the presses are at least partially overlapping in time, regardless of which icon is pressed first). Icons 208a and 208b1 correspond to applications to be invoked, and icon 208b2 corresponds to an instance of application B already running in window 204b.

The touchscreen device may detect this simultaneous pressing of icons 208a, 208b1, and 208b2, and can identify the applications (e.g., applications A and B) associated with the touched icons 208a, 208b1, and 208b2. As noted above, these identified applications can be saved in local memory (e.g., memory of computing device 102-106) in a list of identified applications. For example, the list of identified applications is used by the touchscreen device to determine which applications to invoke or display (e.g., if the application is already running) upon detecting release of multiple touch presses from icons within taskbar 206.

With reference to FIG. 4B, the user may determine that one instance of application B is sufficient, and subsequently release the touch press associated with icon 208b1. The dotted line of finger 210b illustrates that finger 210b has been released from icon 208b1. The touchscreen device can detect the release of the touch press for icon 208b1. In addition, the touchscreen device can remove the application corresponding to the released icon (e.g., icon 208b1) from the identified applications. For example, the touchscreen device can update the list of identified applications by removing the application corresponding to released icon.

FIG. 4C illustrates that the touch press for icons 208a and 208b2 is released (e.g., see dotted lines for fingers 210a 210c), following the prior release of touch press for icon 208b1. Upon detecting the release of fingers 210a and 210c from icons 208a and 208b2, the touchscreen device can invoke applications A and B, and determine a display arrangement to reduce overlapping of windows for applications A and B. As noted above, the touchscreen device can hide the display of windows 204x and 204y within window region 202, invoke application A, and display applications A and B within windows 204a and 204b, respectively.

In another example scenario, the user not may not have released finger 210b from icon 208b1 in FIG. 4B. Instead, the user may have released the touch presses for all icons 208a, 208b1 and 208b2 (e.g., within a threshold period of time), and the touchscreen may detect such release. In response, the touchscreen device may display application A within one window (e.g., window 208a) and display two instances of application B within two separate windows.

Accordingly, FIGS. 2A-2B, 3A-3B and 4A-4C illustrate example user interfaces for arranging windows on a touchscreen device. In example aspects, pseudo code for implementing such arrangement of windows can be as follows:

```
// A variable which contains for each finger a list,
// containing a location and an associated application - or NULL.
List touched_applications = [ ];
OnTouchEvent(event e) {
  if (IsFingerDown(e)) {
  // Identify the application underneath the finger. This could be either a
  // Window - or - an icon in the launcher.
  application = GetApplicationFromLocation(locationOf(e));
  if (application) {
    touched_applications[FingerOf(e)] = [LocationOf(e), application];
  }
  } else if (AllFingersUp(e) && !touched_applications.empty( )) {
  // The list of applications we want to show.
  List applications = [ ];
  // Handle the shown windows.
  if (IsShiftKeyPressed(e)) {
    // Collect all shown windows if Shift is pressed.
    applications = GetShownApplications( );
  } else {
    // Otherwise hide all shown windows.
    List shown_applications = GetShownApplications( );
    for (i = 0; i < sizeof(shwon_applications); i++) {
    HideApplication(shown_applications[i]);
    }
  }
  // Add the list of newly selected applications.
  for (i = 0; i < sizeof(touched_application); i++) {
    if (touched_applications[i]) {
    applications.append(touched_applications[i][1]);
    delete touched_applications[i];
    }
  }
  // Get for each window the non overlapping desktop locations.
  List locations = GetDesktopLocations(sizeof(applications));
  // Position and show each application accordingly.
  for (i = 0; i < sizeof(applications); i++) {
    applications[i].MoveWindow(locations[i]);
    applications[i].ShowWindow( );
  }
  } else if (IsOneFingerUp(e) OR
        (FingerMoved(e) AND
        touched_applications[FingerOf(e)] AND
        GetApplicationFromLocation(locationOf(e)) !=
          touched_applications[FingerOf(e)][1])) {
  // Fingers which wander too far off or get lifted as a single one get
  // removed from the list of fingers.
  delete touched_applications[FingerOf(e)];
  }
}
```

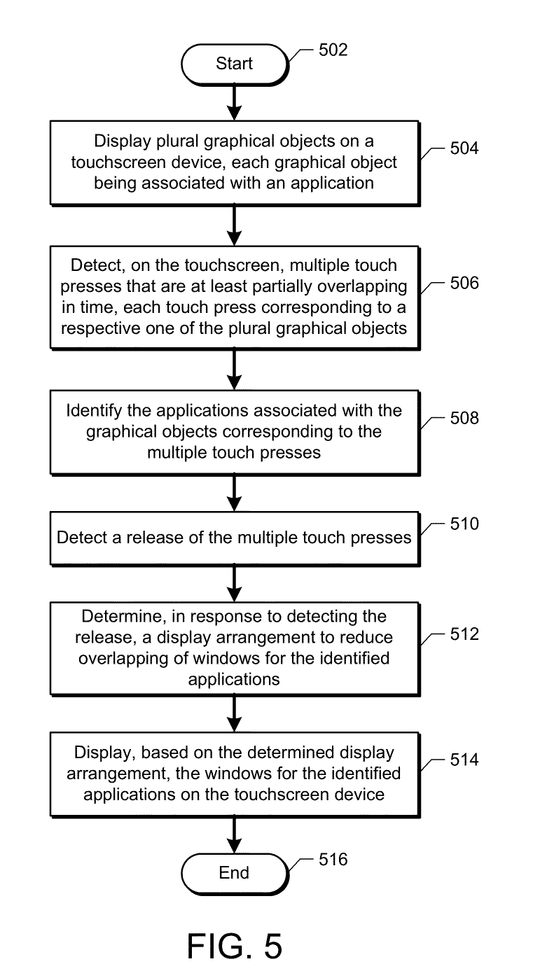

FIG. 5 illustrates an example process by which windows on a touchscreen device are displayed. Following start block 502, plural graphical objects are displayed on a touchscreen of the touchscreen device at step 504. Each graphical object is associated with an application. The plural graphical objects can correspond to windows or icons. The applications can include applications which are already running or applications which are to be invoked.

At step 506, multiple touch presses that are at least partially overlapping in time are detected on the touchscreen. Each touch press corresponds to a respective one of the plural graphical objects. At step 508, the applications associated with the graphical objects corresponding to the multiple touch presses are identified.

At step 510, a release of the multiple touch presses is detected. Prior to detecting the release of the multiple touch presses, a release of a single touch press from the multiple touch presses can be detected. The application associated with the graphical object corresponding to the single touch press can be removed from the identified applications.

In example aspects, prior to detecting the release of the multiple touch presses, a swipe gesture in association with the multiple touch presses can be detected. All of the applications can be removed from the identified applications (e.g., as part of a cancellation operation).

At step 512, in response to detecting the release, a display arrangement to reduce overlapping of windows for the identified applications is determined. The identified applications can be added to a list of applications, and the determining can be based on the list of applications.

The determining can include determining the display arrangement to eliminate overlapping of the windows for the identified applications. Each of the identified applications can correspond to a single window, and the determining can reduce overlapping between each of the single windows.

At step 514, the windows for the identified applications are displayed on the touchscreen based on the determined display arrangement. Existing windows which do not correspond to an identified application can be hidden from display. The determining and the displaying the windows can be based on the hiding of the existing windows.

Alternatively, or in addition, user input to maintain existing windows (e.g., holding the SHIFT key together with the touch presses) for display can be detected. In response to the detected user input, display of the existing windows can be maintained. The determining and the displaying the windows can based on the maintained display of the existing windows. The process then ends at end block 516.

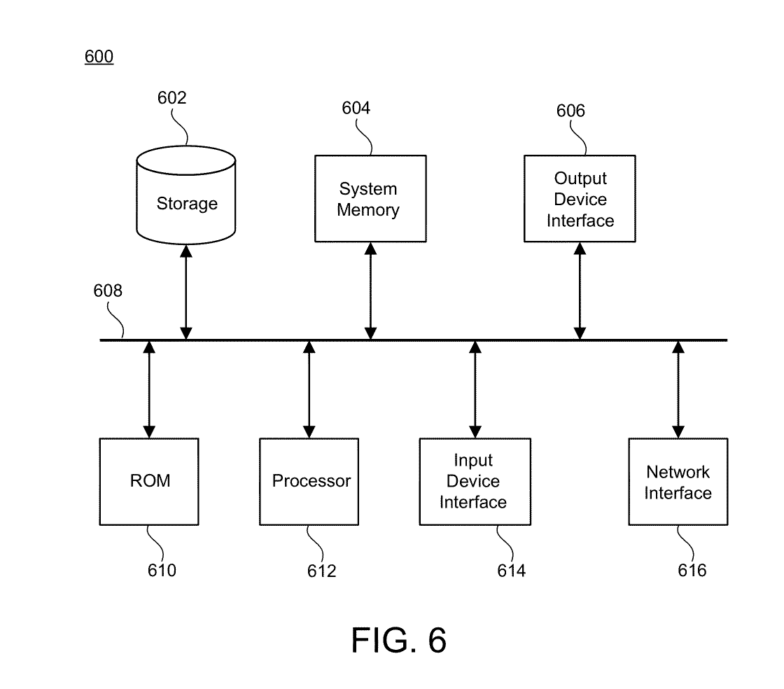

FIG. 6 conceptually illustrates an example electronic system with which some implementations of the subject technology can be implemented. Electronic system 600 can be a computer, phone, PDA, or any other sort of electronic device. Such an electronic system includes various types of computer readable media and interfaces for various other types of computer readable media. Electronic system 600 includes a bus 608, processing unit(s) 612, a system memory 604, a read-only memory (ROM) 610, a permanent storage device 602, an input device interface 614, an output device interface 606, and a network interface 616.

Bus 608 collectively represents all system, peripheral, and chipset buses that communicatively connect the numerous internal devices of electronic system 600. For instance, bus 608 communicatively connects processing unit(s) 612 with ROM 610, system memory 604, and permanent storage device 602.

From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. Some implementations of the subject disclosure use a mass-storage device (for example, a magnetic or optical disk and its corresponding disk drive) as permanent storage device 602.

Other implementations use a removable storage device (for example, a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such a random access memory. System memory 604 stores some of the instructions and data that the processor needs at runtime. In some implementations, the processes of the subject disclosure are stored in system memory 604, permanent storage device 602, or ROM 610. For example, the various memory units include instructions for displaying windows on a touchscreen device in accordance with some implementations. From these various memory units, processing unit(s) 612 retrieves instructions to execute and data to process in order to execute the processes of some implementations.

Bus 608 also connects to input and output device interfaces 614 and 606. Input device interface 614 enables the user to communicate information and select commands to the electronic system. Input devices used with input device interface 614 include, for example, alphanumeric keyboards and pointing devices (also called “cursor control devices”). Output device interfaces 606 enables, for example, the display of images generated by the electronic system 600. Output devices used with output device interface 606 include, for example, printers and display devices, for example, cathode ray tubes (CRT) or liquid crystal displays (LCD). Some implementations include devices, for example, a touchscreen that functions as both input and output devices.

Finally, as shown in FIG. 6, bus 608 also couples electronic system 600 to a network (not shown) through a network interface 616. In this manner, the computer can be a part of a network of computers (for example, a local area network (“LAN”), a wide area network (“WAN”), or an Intranet, or a network of networks, for example, the Internet. Any or all components of electronic system 600 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed is:

1. A machine-implemented method displaying windows on a touchscreen device, the method comprising:
displaying plural graphical objects on a touchscreen of the touchscreen device, each graphical object being associated with an application;
detecting, on the touchscreen, multiple touch presses that are at least partially overlapping in time, each touch press corresponding to a respective one of the plural graphical objects;
identifying the applications associated with the graphical objects corresponding to the multiple touch presses;
detecting a release of the multiple touch presses;
determining, in response to detecting the release, a display arrangement to reduce overlapping of windows for the identified applications; and
displaying, based on the determined display arrangement, the windows for the identified applications on the touchscreen.

2. The method of claim 1, wherein the applications comprise applications which are already running or applications which are invoked.

3. The method of claim 1, wherein the determining comprises determining the display arrangement to eliminate overlapping of the windows for the identified applications.

4. The method of claim 1, further comprising:
hiding existing windows which do not correspond to an identified application from display,
wherein the determining and the displaying the windows are based on the hiding of the existing windows.

5. The method of claim 1, further comprising:
detecting user input to maintain existing windows for display; and
maintaining, in response to the detected user input, display of the existing windows,
wherein the determining and the displaying the windows are based on the maintained display of the existing windows.

6. The method of claim 1, wherein each of the identified applications corresponds to a single window, and wherein the determining reduces overlapping between each of the single windows.

7. The method of claim 1, further comprising, prior to detecting the release of the multiple touch presses:
detecting a release of a single touch press from the multiple touch presses; and
removing the application associated with the graphical object corresponding to the single touch press from the identified applications.

8. The method of claim 1, further comprising, prior to detecting the release of the multiple touch presses:
detecting a swipe gesture in association with the multiple touch presses; and
removing all of the applications from the identified applications.

9. The method of claim 1, wherein the plural graphical objects correspond to windows or icons.

10. The method of claim 1, further comprising:
adding the identified applications to a list of applications, wherein the determining is based on the list of applications.

11. A system for displaying windows, the system comprising:
a touchscreen;
one or more processors; and
a machine-readable medium comprising instructions stored therein, which when executed by the processors, cause the processors to perform operations comprising:
displaying plural graphical objects on the touchscreen, each graphical object being associated with an application already running or to be invoked;
detecting, on the touchscreen, multiple touch presses that are at least partially overlapping in time, each touch press corresponding to a respective one of the plural graphical objects;
identifying the applications associated with the graphical objects corresponding to the multiple touch presses;
detecting a release of the multiple touch presses;
determining, in response to detecting the release, a display arrangement to reduce overlapping of windows for the identified applications; and
displaying, based on the determined display arrangement, the windows for the identified applications on the touchscreen.

12. The system of claim 11, wherein the determining comprises determining the display arrangement to eliminate overlapping of the windows for the identified applications.

13. The system of claim 11, the operations further comprising:
hiding existing windows which do not correspond to an identified application from display,
wherein the determining and the displaying the windows are based on the hiding of the existing windows.

14. The system of claim 11, the operations further comprising:
detecting user input to maintain existing windows for display; and
maintaining, in response to the detected user input, display of the existing windows,
wherein the determining and the displaying the windows are based on the maintained display of the existing windows.

15. The system of claim 11, wherein each of the identified applications corresponds to a single window, and wherein the determining reduces overlapping between each of the single windows.

16. The system of claim 11, the operations further comprising, prior to detecting the release of the multiple touch presses:
detecting a release of a single touch press from the multiple touch presses; and
removing the application associated with the graphical object corresponding to the single touch press from the identified applications.

17. The system of claim 11, the operations further comprising, prior to detecting the release of the multiple touch presses:
detecting a swipe gesture in association with the multiple touch presses; and
removing all of the applications from the identified applications.

18. The system of claim 11, wherein the plural graphical objects correspond to windows or icons.

19. A machine-readable medium comprising instructions stored therein, which when executed by a system, cause the system to perform operations comprising:
displaying plural graphical objects on a touchscreen of a touchscreen device, each graphical object being associated with an application;
detecting, on the touchscreen, multiple touch presses that are at least partially overlapping in time, each touch press corresponding to a respective one of the plural graphical objects;
identifying the applications associated with the graphical objects corresponding to the multiple touch presses;
detecting a release of the multiple touch presses;
determining, in response to detecting the release, a display arrangement of windows for the identified applications; and
displaying, based on the determined display arrangement, the windows for the identified applications on the touchscreen.

20. The machine-readable medium of claim 19, wherein the determining comprises determining the display arrangement to reduce overlapping of the windows for the identified applications.
